(19) United States
(12) Patent Application Publication
(10) Pub. No.: US 2022/0324311 A1
(43) Pub. Date: Oct. 13, 2022

(54) TRAILER COVER SYSTEMS AND METHODS

(71) Applicant: Brumleve Industries, Inc., Teutopolis, IL (US)

(72) Inventor: Michael Brumleve, Teutopolis, IL (US)

(21) Appl. No.: 17/224,452

(22) Filed: Apr. 7, 2021

(51) Int. Cl. B60J 7/16; H04W 76/10; H04W 4/48; H04W 4/80; G06F 3/0481; B60J 7/10; B62D 33/04

(52) U.S. Cl. CPC B60J 7/1607; H04W 76/10; H04W 4/48; H04W 4/80; G06F 3/04817; B60J 7/102; B62D 33/04

(57) ABSTRACT

An exemplary system for covering an open bed of a trailer generally includes an armature movable between an open position and a closed position, a cover connected with the armature such that the bed is exposed when the armature is in the open position and is covered by the cover when the armature is in the closed position, an actuator operably connected with the armature, control circuitry operable to control the actuator to move the armature between the open position and the closed position. The control circuitry includes a wireless communication device, is configured to control the actuator to move the armature toward the open position in response to receiving an open command via the wireless communication device, and is configured to control the actuator to move the armature toward the closed position in response to receiving a close command via the wireless communication device.

### TECHNICAL FIELD

The present disclosure generally relates to movable covers, and more particularly but not exclusively relates to movable covers for trailers.

### BACKGROUND

Open-bed trailers are often provided with cover systems that enable a user to selectively expose and cover the bed. However, many conventional cover systems suffer from certain drawbacks and limitations, such as requiring a user to exit the cab and manually activate the cover system by operating a user interface installed to the outside of the trailer. For these reasons among others, there remains a need for further improvements in this technological field.

### SUMMARY

An exemplary system for covering an open bed of a trailer generally includes an armature movable between an open position and a closed position, a cover connected with the armature such that the bed is exposed when the armature is in the open position and is covered by the cover when the armature is in the closed position, an actuator operably connected with the armature, control circuitry operable to control the actuator to move the armature between the open position and the closed position. The control circuitry includes a wireless communication device, is configured to control the actuator to move the armature toward the open position in response to receiving an open command via the wireless communication device, and is configured to control the actuator to move the armature toward the closed position in response to receiving a close command via the wireless communication device. Further embodiments, forms, features, and aspects of the present application shall become apparent from the description and figures provided herewith.

### BRIEF DESCRIPTION OF THE FIGURES

FIG. 1 is a rear-side view of a trailer according to certain embodiments with an armature in an open position.

FIG. 2 is a rear-side view of the trailer with the armature in a closed position.

FIG. 3 is a schematic block diagram of a system according to certain embodiments.

FIG. 4 is a plan view of control circuitry according to certain embodiments.

FIG. 5 is a schematic circuit diagram of a control circuitry module according to certain embodiments.

FIG. 6 is a schematic circuit diagram of a communications circuitry module according to certain embodiments.

FIG. 7 is a schematic circuit diagram of a voltage regulation circuitry module according to certain embodiments.

FIG. 8 is a schematic circuit diagram of a secondary communications circuitry module according to certain embodiments.

FIG. 9 is a schematic circuit diagram of an outputs circuitry module according to certain embodiments.

FIG. 10 is a schematic circuit diagram of an inputs circuitry module according to certain embodiments.

FIG. 11 illustrates a portion of the trailer with the armature in an open position.

FIG. 12 illustrates a portion of the trailer with the armature in a closed position.

FIG. 13 is a schematic block diagram of a process according to certain embodiments.

FIGS. 14-18 are images of a graphical user interface during various stages of the process illustrated in FIG. 13.

FIGS. 19-21 are schematic block diagrams of processes according to certain embodiments.

FIG. 22 is a schematic block diagram of a computing device according to certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

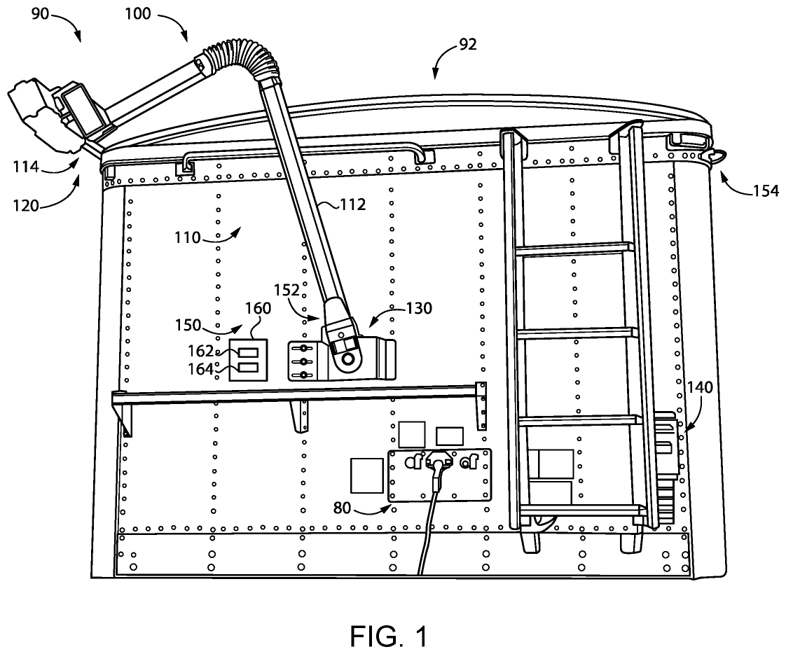

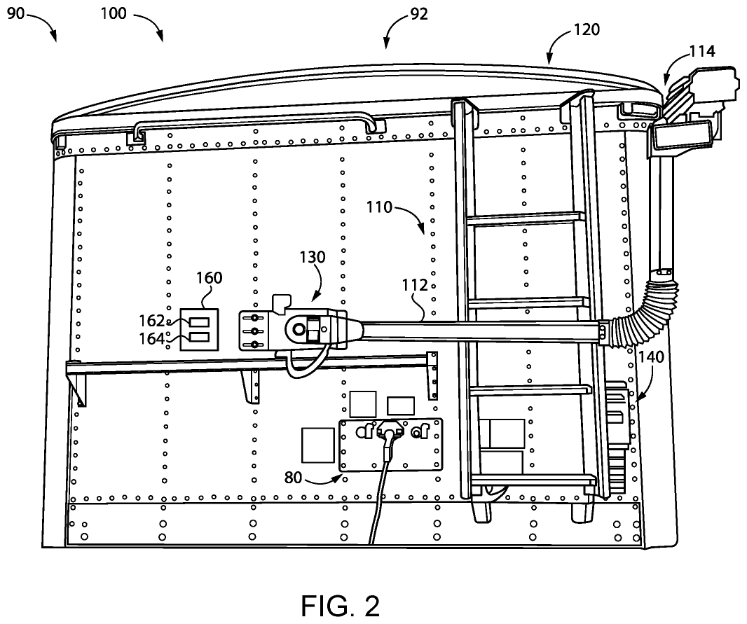

With reference to FIGS. 1 and 2, illustrated therein is a trailer 90 according to certain embodiments. The trailer 90 includes an open bed 92 and a system 100 for selectively covering and exposing the bed 92. The system 100 generally includes an armature 110 movable between an open position (FIG. 1) and a closed position (FIG. 2), a cover 120 connected with the armature 110 such that the bed 92 is exposed when the armature 110 is in the open position and is covered by the cover 120 when the armature 110 is in the closed position, an actuator 130 operably connected with the armature 110, and control circuitry 140 operable to control the actuator 130 to move the armature 110 between the open position and the closed position. In certain embodiments, the system 100 may further include a sensor array 150 in communication with the control circuitry 140 and/or a backup user interface 160 operable to control the actuator 130.

The trailer 90 includes and/or is connected to a power supply 80 operable to supply the system 100 with the requisite electrical power. In the illustrated form, the power supply 80 comprises an electrical connection to an external power source, such as a generator or the battery of a vehicle to which the trailer 90 is coupled. It is also contemplated that the power supply 80 may comprise a power source carried by the trailer 90.

In the illustrated form, the armature 110 is pivotably mounted to the trailer 90 and includes an arm portion 112 and a roll pipe 114 rotatably mounted to the arm portion 112. While the illustrated arm portion 112 is pivotably mounted to a rear side of the trailer 90, it is also contemplated that the arm portion 112 may be mounted at another location. Moreover, while a single arm portion 112 is illustrated, it should be appreciated that a second arm portion may be mounted to the opposite side of the trailer 90 such that the roll pipe 114 extends between the arm portions 112 and is supported by the arm portions 112.

The cover 120 includes a first end coupled to the trailer 90 and an opposite second end coupled with the roll pipe 114. When the armature 110 is in the open position (FIG. 1), the cover 120 is rolled about the roll pipe 114, and the bed 92 is exposed. As the armature 110 moves toward the closed position, the roll pipe 114 rotates and feeds out the cover to at least partially cover the bed 92. When the armature 110 reaches the closed position (FIG. 2), the bed 92 is covered by the cover 120. As the armature 110 moves toward the open position, the roll pipe 114 is rotated to take up the slack in the cover, thereby rolling the cover 120 onto the roll pipe 114. The cover 120 may, for example, be provided in the form of a tarp or a canvas.

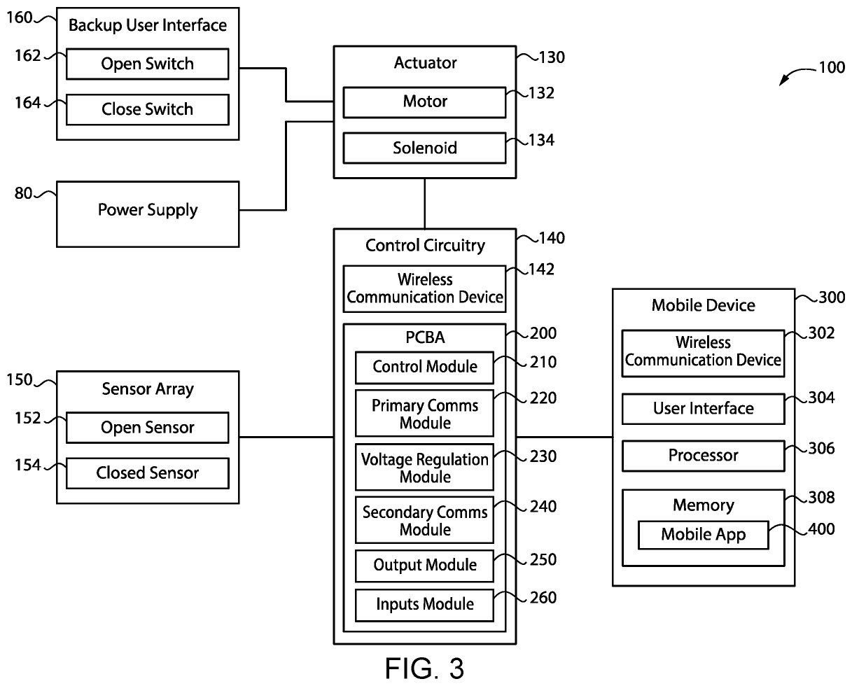

With additional reference to FIG. 3, the illustrated actuator 130 generally includes a motor 132 and a solenoid 134 operable to actuate the motor 132. The motor 132 is operably connected with the armature 110 such that the motor 132 is operable to move the armature 110 between its open position and its closed position. The motor 132 is a reversible motor having a first mode of operation in which the motor 132 moves the armature 110 in an opening direction (i.e., toward the open position) and a second mode of operation in which the motor 132 moves the armature 110 in a closing direction (i.e., toward the closed position). The solenoid 134 is in communication with the control circuitry 140 such that the control circuitry 140 is operable to move the solenoid plunger from a home position to each of a first position and a second position. The solenoid 134 is associated with the motor 132 such that the plunger activates the motor 132 in its first mode when the plunger is in its first position, and such that the plunger activates the motor 132 in its second mode when the plunger is in its second position. Thus, in the illustrated form, the motor 132 is indirectly controlled by the control circuitry 140, which activates the motor 132 by supplying either a positive voltage or a negative voltage to the solenoid 134. It is also contemplated that the motor 132 may be controlled by the control circuitry 140 directly, or through alternative indirect control methods.

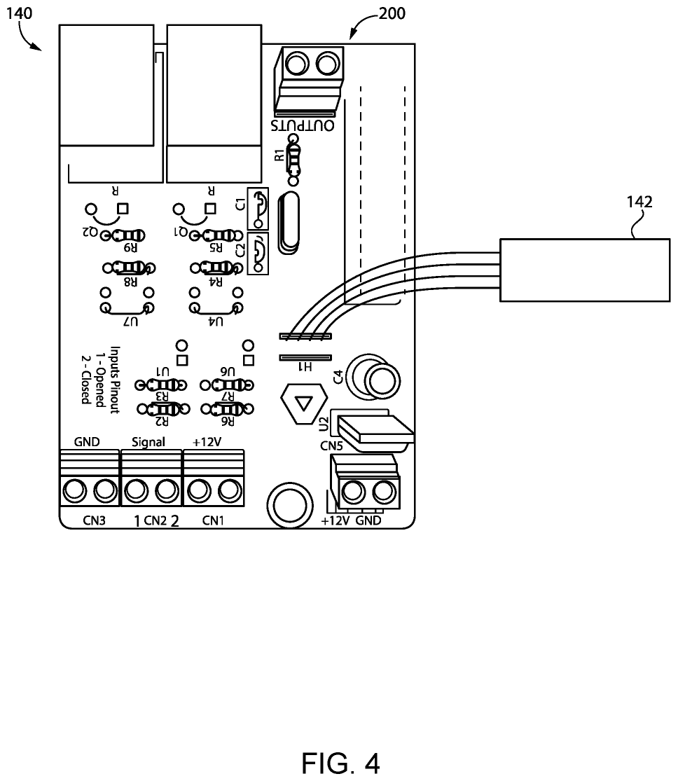

With additional reference to FIG. 4, the control circuitry 140 is configured to control the actuator 130 to move the armature 110 between its open position and its closed position, and may do so in response to commands received wirelessly from a mobile device 300. The illustrated control circuitry 140 generally includes a printed circuit board assembly (PCBA) 200 and a wireless communication device 142 connected with the PCBA 200. In other embodiments, the wireless communication device 142 may be integrated into the PCBA 200. The wireless communication device 142 is operable to wirelessly communicate with a mobile device 300 including a corresponding wireless communication device 302. In the illustrated form, the wireless communication device 142 is provided as a Bluetooth communication device, and more particularly as a Bluetooth Low Energy (BLE) wireless communication device. It is also contemplated that the wireless communication device 142 may be configured to communicate wirelessly via one or more additional or alternative protocols, such as WiFi, Zigbee, and/or other wireless communication protocols.

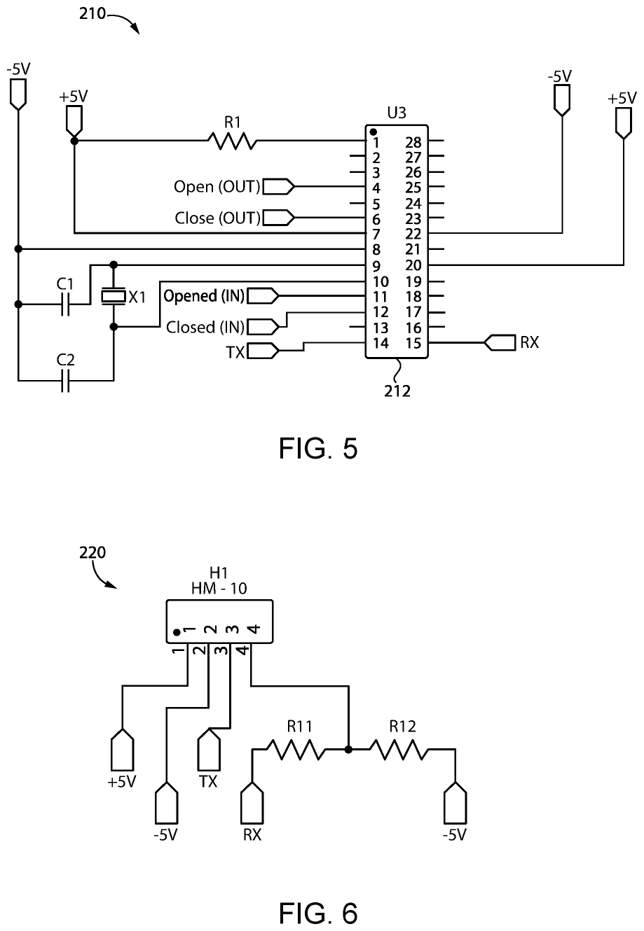

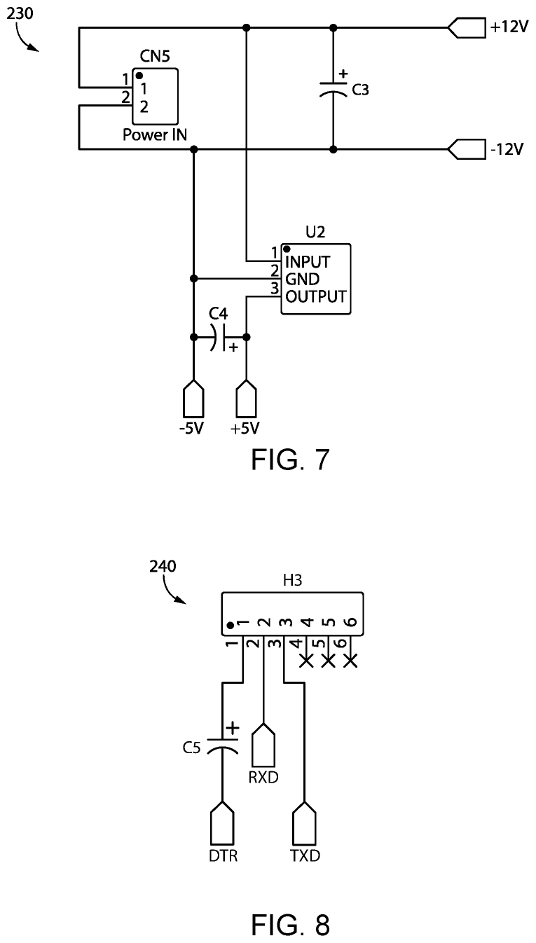

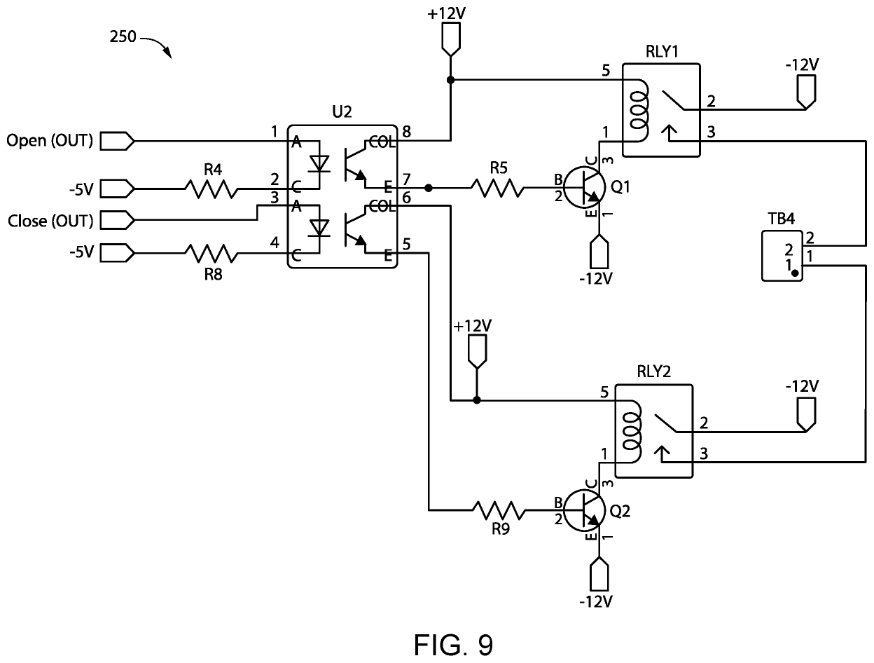

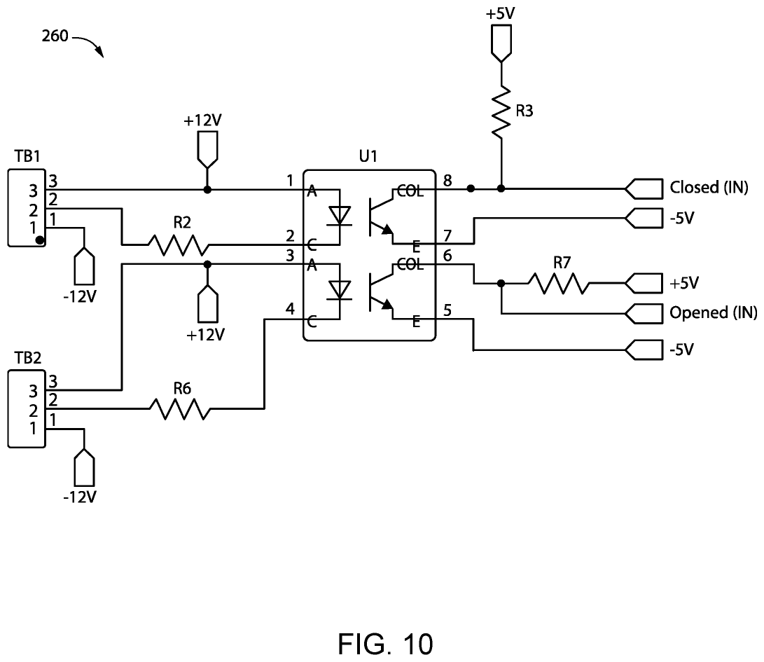

With additional reference to FIGS. 5-10, the PCBA 200 includes a plurality of modules, each of which performs at least one function associated with operation of the control circuitry 140. For example, a control module 210 (FIG. 5) includes a controller 212 that processes information to make decisions that govern operation of the system 100. A primary communications module 220 (FIG. 6) includes the communication pins to which the wireless communication device 142 is coupled, along with a voltage divider. A voltage regulation module 230 (FIG. 7) receives 12VDC electrical power from a power source 80 (e.g., a battery), and converts the 12VDC power to power suitable for use by the control module 210 (e.g., 5VDC power). A secondary communication module 240 (FIG. 8) is an add-on that may be utilized to facilitate troubleshooting. An output module 250 (FIG. 9) controls the open and close signals to be sent to the actuator 130. The illustrated output module 250 includes an isolator that maintains the 12VDC power for the actuator 130 separate from the 5VDC power for the control module 210. An inputs module 260 (FIG. 10) provides 12VDC power to the sensor array 150 and receives the opened and closed signals from the sensor array 150, which in turn activates the isolators to send the signals to the controller 212.

With additional reference to FIGS. 11 and 12, the sensor array 150 is in communication with the control circuitry 140, and generally includes an open position sensor 152 (FIG. 11) and a closed position sensor 154 (FIG. 12), each of which is operable to sense a corresponding position of the armature 110. More particularly, the open position sensor 152 is positioned to sense when the armature 110 is in its open position, and the closed position sensor 154 is positioned to sense when the armature 110 is in its closed position. In the illustrated form, each of the sensors 152, 154 is provided in the form of an inductive position sensor, the output of which changes when a metal object (e.g., the arm portion 112 or the roll pipe 114) is positioned within its sensing area. It is also contemplated that one or both of the sensors 152, 154 may be provided in another form, such as that of a contact switch, a Hall effect sensor, or an optical sensor.

As noted above, each of the illustrated sensors 152, 154 is associated with the armature 110. For example, the open position sensor 152 is associated with the arm portion 112, and is actuated when the armature 110 reaches its open position. Additionally, the closed position sensor 154 is associated with the roll pipe 114, and is actuated when the armature 110 reaches its closed position. It is also contemplated that one or both of the sensors 152, 154 may be associated with another component, so long as the sensor 152/154 remains capable of sensing the appropriate position of the armature 110. As described in further detail herein, the control circuitry 140 may utilize information generated by the sensor array 150 during control of the actuator 130 to move the armature 110 between its open position and its closed position.

The backup user interface 160 is configured to provide an alternative mechanism by which the armature 110 can be moved between its open position and its closed position. The backup user interface 160 may, for example, be utilized when it is inconvenient or infeasible to utilize the mobile device 300 to activate the control circuitry 140. The backup user interface 160 generally includes an opening switch 162 and a closing switch 164, each of which is connected with the actuator 130. When actuated, the opening switch 162 activates the motor 132 in its first mode of operation, thereby driving the armature 110 toward its open position. Conversely, actuation of the closing switch 164 activates the motor 132 in its second mode of operation, thereby driving the armature 110 toward its closed position. In the illustrated form, each of the opening switch 162 and the closing switch 164 is provided in the form of a momentary switch that must be held down to remain actuated. It is also contemplated that one or both of the switches 162, 164 may be provided in another form, such as that of a toggle that remains in one state until manually driven to the other state.

The mobile device 300 is operable to receive user input and to transmit to the system 100 commands corresponding to the received user input. The mobile device 300 generally includes a wireless communication device 302, a user interface 304, a processor 306, and memory 308 having stored thereon an application 400. The mobile device 302 may, for example, take the form of a smart phone, a tablet, a laptop computer, or another form of mobile device. While some example features regarding the mobile device 300 will now be discussed, further details regarding additional and/or alternative features that may be associated with the mobile device 300 are provided below with reference to FIG. 22.

The wireless communication device 302 is operable to wirelessly communicate with the wireless communication device 142 of the control circuitry 140. In the illustrated form, the wireless communication devices 142, 302 comprise Bluetooth communication devices operable to pair with one another and to wirelessly transmit data via a Bluetooth protocol. It is also contemplated that the wireless communication devices 142, 302 may communicate via one or more additional or alternative protocols, such as WiFi and/or Zigbee.

The user interface 304 is operable to provide information to a user and/or receive input from the user. The user interface 304 may, for example, comprise a touchscreen operable to display information and to receive tactile input from the user. In certain embodiments, the user interface 304 may include one or more outputs, such as one or more visual outputs (e.g., a display and/or an indicator) and/or one or more audio outputs (e.g., a speaker, a buzzer, and/or a beeper). In certain embodiments, the user interface 304 may include one or more input devices, such as a keyboard, a mouse, a touchpad, a touchscreen, a microphone, an inertial sensor, and/or other input devices.

The processor 306 is in communication with the wireless communication device 302 and is operable to send and receive information wirelessly via the wireless communication device 302. The processor 306 is also in communication with the user interface 304 such that the processor 306 is operable to provide the user with information via the user interface 304 and is operable to receive user input via the user interface 304. The processor 306 is also in communication with the memory 308 such that information stored in the memory 308 (including the mobile app 400) is accessible to the processor 306.

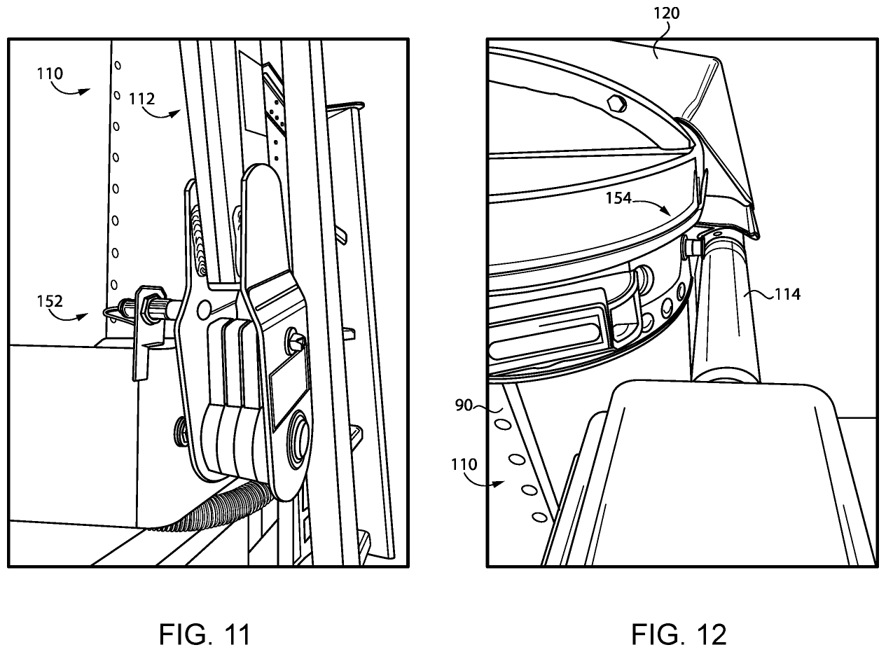

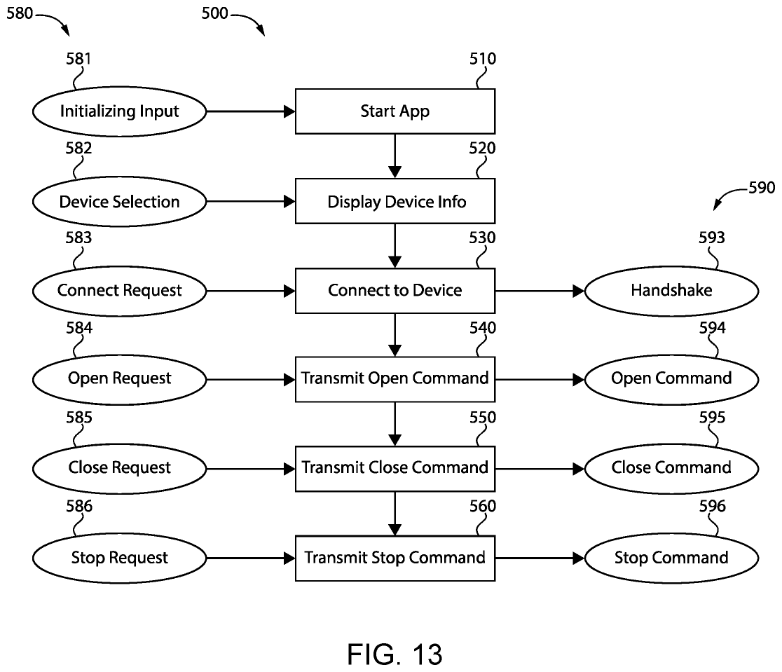

The memory 308 is a non-transitory computer readable medium operable to store information in a format usable by the processor 306. The memory 308 is operable to store instructions executable by the processor 306 such that execution of the instructions by the processor 306 causes the mobile device 300 to perform one or more actions. For example, the mobile app 400 includes instructions that, when executed by the processor 306, cause the mobile device 300 to perform one or more of the actions described below with reference to the processes 500, 600, 700 illustrated in FIGS. 13, 19, and 20.

With additional reference to FIG. 13, an exemplary process 500 that may be performed using the mobile device 300 and the app 400 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another.

The process 500 generally includes a plurality of blocks, one or more of which may be performed in response to a user input 580, and one or more of which may involve the transmission and/or receipt of wireless information 590 via the wireless communication device 302. As will be appreciated, the process 500 may be performed in connection with the app 400, which may include instructions that, when executed by the processor 306, cause the mobile device 300 to perform the acts described herein.

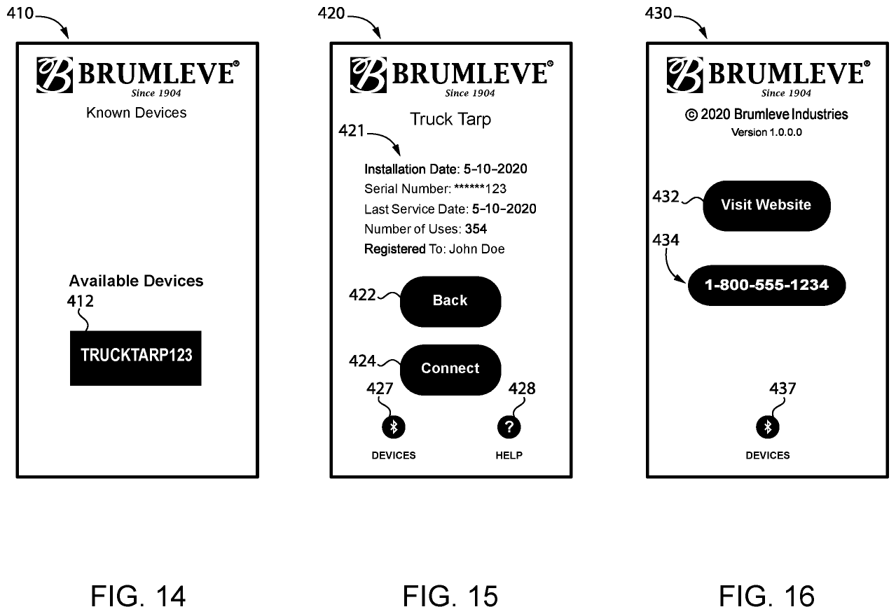

With additional reference to FIG. 14, the process 500 may begin with block 510, which generally involves starting the app 400. Block 510 may, for example, be performed in response to an initializing input, such as the user selecting an icon associated with the app 400 via the user interface 304. Block 510 may involve causing the mobile device 300 to display the welcome screen 410 illustrated in FIG. 14. The screen 410 includes an icon 412 identifying an available device (e.g., the system 100) with which the app 400 is compatible. Block 510 may, for example, involve sending and/or receiving wireless advertisements to determine which available devices are within wireless communication range, and displaying the icon 412 in response to identifying such an available device. In response to a device selection input 582 indicating a user's desire to select a displayed device (e.g., via selection of the icon 412), the process 500 may continue to block 520.

With additional reference to FIG. 15, the process 500 may include block 520, which generally involves displaying information related to the selected device. For example, block 520 may involve displaying a device information screen 420, which includes information 421 related to the selected device (e.g., the system 100). The information 421 may, for example, indicate one or more of the installation date of the selected device, the serial number of the selected device, the last service date of the selected device, the number of times the selected device has been used, and/or the registered user of the selected device. The screen 420 may include a back icon 422 that, when selected by the user, returns the mobile device 300 to the screen 410 illustrated in FIG. 14. The screen 420 may include a devices icon that, when selected by the user, returns the mobile device 300 to the screen 410 illustrated in FIG. 14.

With additional reference to FIG. 16, the device information screen 420 may include a help icon that, when selected by the user, causes the mobile device 300 to display a help screen 430. In certain embodiments, the help screen 430 may include a website icon 432 that, when selected by the user, causes the mobile device 300 to access a website associated with a manufacturer of the system 100 a developer of the app 400, and/or a third party contracted to provide support services. The help screen 430 may additionally or alternatively include a phone icon 434 that, when selected by the user, causes the mobile device 300 to dial a help line.

Returning to FIG. 15, the device information screen 420 may include a connect icon 324 that, when selected by the user, causes the mobile device 300 to establish a wireless communication connection with the selected device (e.g., the system 100). Selection of the connect icon 324 is one example of a connect request 583 that may cause the process 500 to continue to block 530, which generally involves connecting to the selected device. For example, block 530 may involve sending and/or receiving information in the form of a handshake to establish the wireless communication connection between the mobile device 300 and the control circuitry 140 of the system 100.

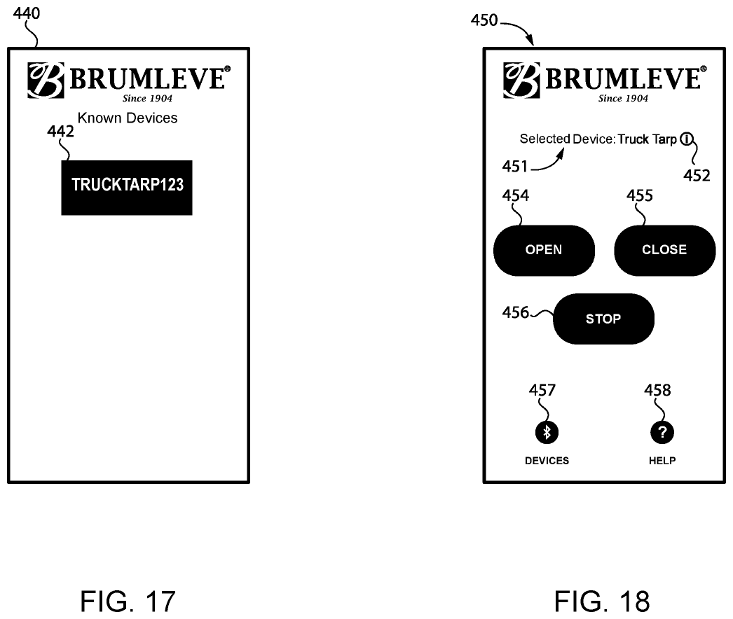

With additional reference to FIG. 17, upon connecting to the selected device (e.g., the system 100), the mobile device 300 may display a device selection screen 440. The device selection screen 440 is similar to the screen 410, but now includes an icon 442 corresponding to the selected device in a “known devices” region of the screen 440.

With additional reference to FIG. 18, selection of the icon 442 may cause the mobile device 300 to display an operation screen 450. The operation screen 450 may include information 451 identifying the selected device and/or an information icon 452 that, when selected by the user, causes the mobile device 300 to return to the device information screen 420 illustrated in FIG. 15. The operation screen 450 may include a devices icon 457 that, when selected by the user, causes the mobile device 300 to return to the device selection screen 440. The operation screen 450 may include a help icon 458 that, when selected by the user, causes the mobile device 300 to return to the help screen 430 illustrated in FIG. 16.

The illustrated operation screen 450 includes an open icon 454, selection of which is one example of an open request 584 indicating the user's desire to at least partially expose the bed 92 of the trailer 90. In response to the open request 584, the process 500 may proceed to block 540, which generally involves transmitting an open command 594 via the wireless communication connection.

The illustrated operation screen 450 also includes a close icon 455, selection of which is one example of a close request 585 indicating the user's desire to at least partially cover the bed 92 of the trailer 90. In response to the close request 585, the process 500 may proceed to block 550, which generally involves transmitting a close command 595 via the wireless communication connection.

The illustrated operation screen 450 further includes a stop icon 456, selection of which is one example of a stop request 586 indicating the user's desire to stop movement of the armature 110. In response to the stop request 586, the process 500 may proceed to block 560, which generally involves transmitting a stop command 596 via the wireless communication connection.

While each of the user inputs 580 has been described herein with reference to selection of a displayed icon, it should be appreciated that other forms of user input are contemplated. For example, one or more of the inputs 580 may be provided vocally, and the app 400 may process information received via a microphone to interpret the vocal commands.

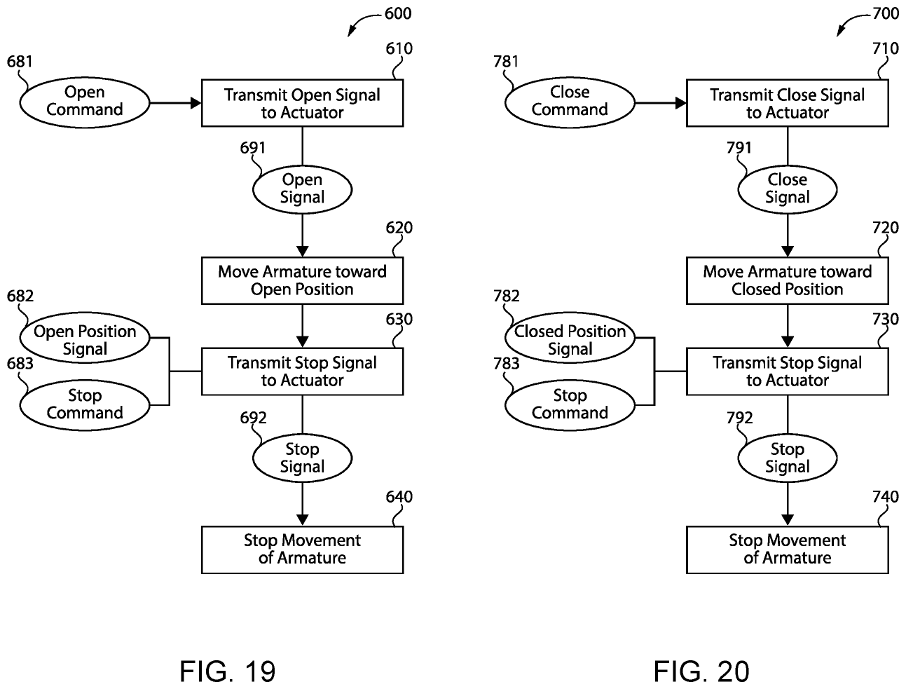

With additional reference to FIG. 19, an exemplary process 600 that may be performed using the system 100 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another.

The process 600 generally involves at least partially opening the trailer 90, and may begin with the armature 110 in its closed position or an intermediate position between the open position and the closed position. As will be appreciated, the process 600 may be performed in connection with the mobile device 300 and the process 500 illustrated in FIG. 13. For example, the process 600 may be performed once the wireless communication connection has been formed between the system 100 and the mobile device 300 in block 530 of the process 500.

The process 600 may begin in response to an open command 681, such as the open command 594 transmitted by the mobile device 300 in block 540 of the above-described process 500. In response to the open command 681, the control circuitry 140 performs block 610, which generally involves transmitting an open signal 691 to the actuator 130.

The process 600 also includes block 620, which generally involves moving the armature 110 toward its open position. Block 620 may be performed by the actuator 130 in response to receiving the open signal 691 from the control circuitry 140. In the illustrated form, the open signal 691 causes the solenoid 134 to activate the motor 132 in its first operating mode, thereby moving the armature 110 toward its open position. Additionally, the actuator 130 continues moving the armature 110 toward its open position until a stop signal 692 is received from the control circuitry 140. In certain embodiments, the open signal 691 may be provided in the form of electrical power of a first voltage (e.g., +12VDC), and the stop signal 692 may be provided in the form of cessation of such electrical power.

The process 600 also includes block 630, which generally involves the control circuitry 140 transmitting the stop signal 692 to the actuator 130 (e.g., by ceasing transmission of the open signal 691). In certain forms, block 630 may be performed in response to receiving an open position signal 682 indicative of the armature 110 having reached its open position. The open position signal 682 may, for example, be based upon information generated by the open position sensor 152. In certain forms, block 630 may be performed in response to receiving a stop command 683, such as the stop command 596 transmitted in block 560 of the process 500. In certain forms, each of the open position signal 682 and the stop command 683 is individually sufficient to proceed to block 630 such that block 630 is performed in response to each and either of the open position signal 682 and the stop command 683.

With the stop signal 692 transmitted to the actuator 130 (e.g., by ceasing transmission of the open signal 691), the process 600 may continue to block 640, which generally involves stopping movement of the armature 110. In the illustrated form, the stop signal 692 causes the solenoid 134 to deactivate the motor 132, thereby stopping movement of the armature 110.

With additional reference to FIG. 20, an exemplary process 700 that may be performed using the system 100 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another.

The process 700 generally involves at least partially closing the trailer 90, and may begin with the armature 110 in its open position or an intermediate position between the open position and the closed position. As will be appreciated, the process 700 may be performed in connection with the mobile device 300 and the process 500 illustrated in FIG. 13. For example, the process 700 may be performed once the wireless communication connection has been formed between the system 100 and the mobile device 300 in block 530 of the process 500.

The process 700 may begin in response to a close command 781, such as the close command 595 transmitted by the mobile device 300 in block 550 of the above-described process 500. In response to the close command 781, the control circuitry 140 performs block 710, which generally involves transmitting a close signal 791 to the actuator 130.

The process 700 also includes block 720, which generally involves moving the armature 110 toward its closed position. Block 720 may be performed by the actuator 130 in response to receiving the close signal 791 from the control circuitry 140. In the illustrated form, the close signal 791 causes the solenoid 134 to activate the motor 132 in its second operating mode, thereby moving the armature 110 toward its closed position. Additionally, the actuator 130 continues moving the armature 110 toward its closed position until a stop signal 792 is received from the control circuitry 140. In certain embodiments, the close signal 791 may be provided in the form of electrical power of a second voltage (e.g., −12VDC), and the stop signal 792 may be provided in the form of cessation of such electrical power.

The process 700 also includes block 730, which generally involves the control circuitry 140 transmitting the stop signal 792 to the actuator 130 (e.g., by ceasing transmission of the close signal 791). In certain forms, block 730 may be performed in response to receiving a closed position signal 782 indicative of the armature 110 having reached its closed position. The closed position signal 782 may, for example, be based upon information generated by the closed position sensor 154. In certain forms, block 730 may be performed in response to receiving a stop command 783, such as the stop command 596 transmitted in block 560 of the process 500. In certain forms, each of the closed position signal 782 and the stop command 783 is individually sufficient to proceed to block 730 such that block 730 is performed in response to each and either of the closed position signal 782 and the stop command 783.

With the stop signal 792 transmitted to the actuator 130 (e.g., by ceasing transmission of the close signal 791), the process 700 may continue to block 740, which generally involves stopping movement of the armature 110. In the illustrated form, the stop signal 792 causes the solenoid 134 to deactivate the motor 132, thereby stopping movement of the armature 110.

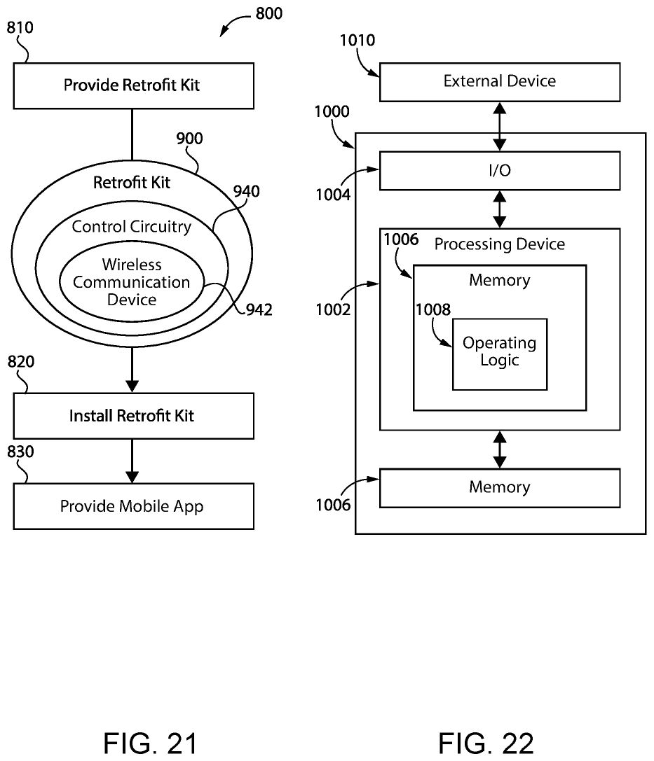

With additional reference to FIG. 21, illustrated therein is a process 800 for retrofitting an existing trailer to form a wirelessly-operable trailer 90. The existing trailer includes an armature 110, a cover 120 connected with the armature 110, an actuator 130 operably connected with the armature 110, and an existing user interface operable to cause the actuator to move the armature 110 between an open position and a closed position to thereby cause the cover 120 to selectively expose a bed 92 of the trailer 90 and to selectively cover the bed 92 of the trailer 90.

In certain embodiments, the process 800 includes block 810, which generally involves providing a retrofit kit 900 configured for use with the existing trailer. The retrofit kit 900 generally includes control circuitry 940 including a first wireless communication device 942. The control circuitry 940, when connected with the actuator 130, is configured to control the actuator 130 to move the armature 110 toward the open position in response to receiving an open command via the first wireless communication device 942. The control circuitry 940, when connected with the actuator 130, is further configured to control the actuator 130 to move the armature 110 toward the closed position in response to receiving a close command via the first wireless communication device 942. An exemplary form of such control circuitry 940 is described above with reference to the control circuitry 140. Stated another way, the control circuitry 940 of the retrofit kit 900 may, for example, correspond to the control circuitry 140 of the above-described system 100.

In certain embodiments, the process 800 includes block 820, which generally involves installing the retrofit kit 900 provided in block 810. More particularly, block 820 involves replacing the user interface of the existing trailer with at least a portion of the retrofit kit 900, the at least a portion of the retrofit kit comprising the control circuitry 940. When so installed, the control circuitry 940 may be operable to receive wireless open commands, wireless close commands, and/or wireless stop commands via the wireless communications device 942, and to operate the actuator 130 in response to receiving such commands.

In addition or as an alternative to blocks 810 and/or 820, the process 800 may include block 830, which generally involves providing, to a mobile device 300 comprising a second wireless communication device 302, an application (e.g., the mobile app 400) comprising a plurality of instructions that, when executed by a processor 306 of the mobile device 300, cause the mobile device 300 to wirelessly transmit the open command via the second wireless communication device 302 in response to a first user input, and wirelessly transmit the close command via the second wireless communication device 302 in response to a second user input. In certain embodiments, the plurality of instructions, when executed by the processor 306, cause the mobile device 300 to wirelessly transmit a stop command via the second wireless communication device 302 in response to a third user input. In such forms, the control circuitry 940 may further be configured to stop the actuator 130 in response to the stop command. In certain embodiments, the plurality of instructions, when executed by the processor 306, further cause the mobile device 300 to display an open icon 454 and a close icon 455. In such forms, the first user input may comprise selection of the open icon 454, and the second user input may comprise selection of the close icon 455.

Referring now to FIG. 22, a simplified block diagram of at least one embodiment of a computing device 1000 is shown. The illustrative computing device 1000 depicts at least one embodiment of a controller that may be utilized in connection with the controller 212 illustrated in FIG. 5. Further, in some embodiments, the illustrative computing device 1000 depicts at least one embodiment of a mobile device that may be utilized in connection with the mobile device 300 illustrated in FIG. 3.

Depending on the particular embodiment, the computing device 1000 may be embodied as a server, desktop computer, laptop computer, tablet computer, notebook, netbook, UltrabookTM, mobile computing device, cellular phone, smartphone, wearable computing device, personal digital assistant, Internet of Things (IoT) device, control panel, processing system, router, gateway, and/or any other computing, processing, and/or communication device capable of performing the functions described herein.

The computing device 1000 includes a processing device 1002 that executes algorithms and/or processes data in accordance with operating logic 1008, an input/output device 1004 that enables communication between the computing device 1000 and one or more external devices 1010, and memory 1006 which stores, for example, data received from the external device 1010 via the input/output device 1004.

The input/output device 1004 allows the computing device 1000 to communicate with the external device 1010. For example, the input/output device 1004 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Bluetooth Low Energy (BLE), Wi-Fi®, WiMAX, etc.) to effect such communication depending on the particular computing device 1000. The input/output device 1004 may include hardware, software, and/or firmware suitable for performing the techniques described herein.

The external device 1010 may be any type of device that allows data to be inputted or outputted from the computing device 1000. For example, in various embodiments, the external device 1010 may be embodied as the actuator 130, the control circuitry 140, the sensor array 150, or the mobile device 300. Further, in some embodiments, the external device 1010 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 1010 may be integrated into the computing device 1000.

The processing device 1002 may be embodied as any type of processor(s) capable of performing the functions described herein. In particular, the processing device 1002 may be embodied as one or more single or multi-core processors, microcontrollers, or other processor or processing/controlling circuits. For example, in some embodiments, the processing device 1002 may include or be embodied as an arithmetic logic unit (ALU), central processing unit (CPU), digital signal processor (DSP), and/or another suitable processor(s). The processing device 1002 may be a programmable type, a dedicated hardwired state machine, or a combination thereof. Processing devices 1002 with multiple processing units may utilize distributed, pipelined, and/or parallel processing in various embodiments. Further, the processing device 1002 may be dedicated to performance of just the operations described herein, or may be utilized in one or more additional applications. In the illustrative embodiment, the processing device 1002 is of a programmable variety that executes algorithms and/or processes data in accordance with operating logic 1008 as defined by programming instructions (such as software or firmware) stored in memory 1006. Additionally or alternatively, the operating logic 1008 for processing device 1002 may be at least partially defined by hardwired logic or other hardware. Further, the processing device 1002 may include one or more components of any type suitable to process the signals received from input/output device 1004 or from other components or devices and to provide desired output signals. Such components may include digital circuitry, analog circuitry, or a combination thereof.

The memory 1006 may be of one or more types of non-transitory computer-readable media, such as a solid-state memory, electromagnetic memory, optical memory, or a combination thereof. Furthermore, the memory 1006 may be volatile and/or nonvolatile and, in some embodiments, some or all of the memory 1006 may be of a portable variety, such as a disk, tape, memory stick, cartridge, and/or other suitable portable memory. In operation, the memory 1006 may store various data and software used during operation of the computing device 1000 such as operating systems, applications, programs, libraries, and drivers. It should be appreciated that the memory 1006 may store data that is manipulated by the operating logic 1008 of processing device 1002, such as, for example, data representative of signals received from and/or sent to the input/output device 1004 in addition to or in lieu of storing programming instructions defining operating logic 1008. As illustrated, the memory 1006 may be included with the processing device 1002 and/or coupled to the processing device 1002 depending on the particular embodiment. For example, in some embodiments, the processing device 1002, the memory 1006, and/or other components of the computing device 1000 may form a portion of a system-on-a-chip (SoC) and be incorporated on a single integrated circuit chip.

In some embodiments, various components of the computing device 1000 (e.g., the processing device 1002 and the memory 1006) may be communicatively coupled via an input/output subsystem, which may be embodied as circuitry and/or components to facilitate input/output operations with the processing device 1002, the memory 1006, and other components of the computing device 1000. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 1000 may include other or additional components, such as those commonly found in a typical computing device (e.g., various input/output devices and/or other components), in other embodiments. It should be further appreciated that one or more of the components of the computing device 1000 described herein may be distributed across multiple computing devices. In other words, the techniques described herein may be employed by a computing system that includes one or more computing devices. Additionally, although only a single processing device 1002, I/O device 1004, and memory 1006 are illustratively shown in FIG. 22, it should be appreciated that a particular computing device 1000 may include multiple processing devices 1002, I/O devices 1004, and/or memories 1006 in other embodiments. Further, in some embodiments, more than one external device 1010 may be in communication with the computing device 1000.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system for covering an open bed of a trailer, the system comprising:
an armature movable between an open position and a closed position;
a cover connected with the armature such that the bed is exposed when the armature is in the open position and is covered by the cover when the armature is in the closed position;
an actuator operably connected with the armature; and
control circuitry operable to control the actuator to move the armature between the open position and the closed position;
wherein the control circuitry comprises a wireless communication device;
wherein the control circuitry is configured to control the actuator to move the armature toward the open position in response to receiving an open command via the wireless communication device; and
wherein the control circuitry is configured to control the actuator to move the armature toward the closed position in response to receiving a close command via the wireless communication device.

2. The system of claim 1, wherein the wireless communication device is configured to receive the open command and the closed command via a Bluetooth protocol.

3. The system of claim 1, further comprising an open position sensor in communication with the control circuitry;
wherein to control the actuator to move the armature toward the open position comprises deactivating the actuator in response to information generated by the open position sensor indicating that the armature has reached the open position.

4. The system of claim 1, further comprising a closed position sensor in communication with the control circuitry;
wherein to control the actuator to move the armature toward the closed position comprises deactivating the actuator in response to information generated by the closed position sensor indicating that the armature has reached the closed position.

5. The system of claim 1, wherein to control the actuator to move the armature toward the open position comprises activating the actuator to move the armature toward the open position, and deactivating the actuator to stop movement of the armature in response to an earlier of (i) an open position sensor indicating that the armature has reached the open position, and (ii) receipt of a stop command via the wireless communication device.

6. The system of claim 1, wherein to control the actuator to move the armature toward the closed position comprises activating the actuator to move the armature toward the closed position, and deactivating the actuator to stop movement of the armature in response to an earlier of (i) a closed position sensor indicating that the armature has reached the closed position, and (ii) receipt of a stop command via the wireless communication device.

7. The system of claim 1, further comprising a backup open switch, wherein the actuator is configured to move the armature toward the open position in response to actuation of the backup open switch.

8. The system of claim 1, further comprising a backup close switch, wherein the actuator is configured to move the armature toward the closed position in response to actuation of the backup close switch.

9. A trailer comprising the system of claim 1.

10. A method, comprising:
providing a retrofit kit operable to replace at least a portion of an existing user interface of a trailer comprising an armature, a cover connected with the armature, an actuator operably connected with the armature, and the existing user interface, wherein the existing user interface is operable to cause the actuator to move the armature between an open position and a closed position to thereby cause the cover to selectively expose a bed of the trailer and to selectively cover the bed of the trailer;
wherein the retrofit kit comprises control circuitry including a first wireless communication device;
wherein the control circuitry, when connected with the actuator, is configured to control the actuator to move the armature toward the open position in response to receiving an open command via the first wireless communication device; and
wherein the control circuitry, when connected with the actuator, is configured to control the actuator to move the armature toward the closed position in response to receiving a close command via the first wireless communication device.

11. The method of claim 10, further comprising installing the retrofit kit to the trailer, wherein the installing comprises replacing at least a portion of the user interface with the control circuitry.

12. The method of claim 10, further comprising providing, to a mobile device comprising a second wireless communication device, an application comprising a plurality of instructions that, when executed by a processor of the mobile device, cause the mobile device to:
wirelessly transmit the open command via the second wireless communication device in response to a first user input; and
wirelessly transmit the close command via the second wireless communication device in response to a second user input.

13. The method of claim 12, wherein the plurality of instructions, when executed by the processor, further cause the mobile device to wirelessly transmit a stop command via the second wireless communication device in response to a third user input; and
wherein the control circuitry is further configured to stop the actuator in response to the stop command.

14. The method of claim 12, wherein the plurality of instructions, when executed by the processor, further cause the mobile device to display an open icon and a close icon;
wherein the first user input comprises selection of the open icon; and
wherein the second user input comprises selection of the close icon.

15. A method, comprising:
receiving, by a mobile device comprising a first wireless communication device, a first user input indicating a user desire to one of (a) expose a bed of a trailer, or (b) cover the bed of the trailer, wherein the trailer comprises:
an armature movable between an open position and a closed position;
a cover connected with the armature such that the bed is exposed when the armature is in the open position and is covered by the cover when the armature is in the closed position;
an actuator operably connected with the armature; and
control circuitry operable to control the actuator to move the armature between the open position and the closed position, the control circuitry comprising a second wireless communication device;
in response to receiving the first user input, transmitting, by the mobile device and via the first wireless communication device, an open/close command comprising one of an open command or a close command;
wherein the control circuitry, in response to receiving the open/closed command via the second wireless communication device, controls the actuator to move the armature toward one of the open position or the closed position.

16. The method of claim 15, further comprising:
receiving, by the mobile device, a second user input indicating a user desire to stop movement of the armature;
in response to receiving the second user input, transmitting, by the mobile device and via the first wireless communication device, a stop command;
wherein the control circuitry, in response to receiving the stop command via the second wireless communication device, controls the actuator to stop movement of the armature.

17. The method of claim 15, further comprising:
generating, by a position sensor in communication with the control circuitry, a stop signal in response to the armature reaching the one of the open position or the closed position; and
in response to receiving the stop signal, controlling, by the control circuitry, the actuator to stop movement of the armature.

18. The method of claim 15, wherein the first wireless communication device comprises a first Bluetooth communication device;
wherein the second wireless communication device comprises a second Bluetooth communication device;
wherein the method further comprises establishing a Bluetooth connection between the first Bluetooth communication device and the second Bluetooth communication device; and
wherein transmitting the open/close command comprises transmitting the open/closed command via the Bluetooth connection.

19. A method of operating a mobile device operable to wirelessly communicate with control circuitry of a trailer, the method comprising:
receiving, by the mobile device, a first user input indicating a user desire to expose a bed of the trailer;
in response to receiving the first user input, transmitting, via a wireless communication connection formed between a first wireless communication device of the mobile device and a second wireless communication device of the control circuitry, an open command operable to cause the control circuitry to control an actuator to move an armature toward an open position, thereby at least partially exposing the bed;
receiving, by the mobile device, a second user input indicating a user desire to cover the bed of the trailer;
in response to receiving the second user input, transmitting, via the wireless communication connection, a close command operable to cause the control circuitry to control the actuator to move the armature toward a closed position, thereby at least partially covering the bed.

20. The method of claim 19, further comprising:
receiving, by the mobile device, a third user input indicating a user desire to stop movement of the armature;
in response to receiving the second user input, transmitting, via the wireless communication connection, a stop command operable to cause the control circuitry to control the actuator to stop movement of the armature.

21. The method of claim 19, further comprising displaying, via a graphical user interface of the mobile device, a stop icon;
wherein the third user input comprises selection of the stop icon.

22. The method of claim 19, further comprising displaying, via a graphical user interface of the mobile device, each of an open icon and a closed icon;
wherein the first user input comprises selection of the open icon; and
wherein the second user input comprises selection of the closed icon.
